(19) United States
(12) Patent Application Publication
(10) Pub. No.: US 2022/0383226 A1
(43) Pub. Date: Dec. 1, 2022

(54) CUSTOMER EXPERIENCE INDICATORS DEVELOPMENT

(71) Applicant: RAKUTEN MOBILE, INC, Tokyo (JP)

(72) Inventors: Ahmed ALAAELDIN, Kanagawa (JP); Ahmed ABDELAZIZ, Tokyo (JP); Trevor WIELAND, Tokyo (JP)

(73) Assignee: RAKUTEN MOBILE, INC., Tokyo (JP)

(21) Appl. No.: 17/580,719

(22) Filed: Jan. 21, 2022

Related U.S. Application Data
(60) Provisional application No. 63/194,559, filed on May 28, 2021.

(51) Int. Cl. G06Q 10/06; G06Q 30/00; G06N 5/02

(52) U.S. Cl. CPC G06Q 10/06393; G06Q 30/016; G06N 5/022

(57) ABSTRACT

There is included a method and apparatus comprising computer code configured to cause a processor or processors to perform providing services to a customer, measuring key performance indicators, obtaining dynamic KPI weights, normalizing values indicated by the KPIs and separating the normalized values into groups based on priority information, and changing the customer from a first cluster of first customers to a second cluster of second customers based on based on at least one of the KPIs.

### CROSS REFERENCE TO RELATED APPLICATION

### Background

### 1. Field

The present disclosure is directed to developing customer experience indices per service to accurately reflect network experience through subscriber level key performance indicators and customer information.

### 2. Description of Related Art

Networked services, such as video, data, voice, among others, may be provided across a network with different performances at different times and to different users, not necessarily based on an intent of the network but instead based on inherent technical limitations and discrepancies throughout the network. Accordingly, the users may experience differences in quality with respect to one or more of those services, and due to such technical limitations on the network, such services have been incapable of accurately capturing actual experiences of customers regardless of the customer's own feedback with respect to such services.

### SUMMARY

To address one or more different technical problems, this disclosure provides technical solutions to reduce network overhead and server computational overheads while delivering an option to apply various operations to the resolved element such that in using these operations some of the properties like the connection to the live server may be maintained for example.

Exemplary embodiments herein provide a reduction of null values, drastically reduced setup and adjustment times, easy separation of services, easy addition or removal of services and key performance indicators (KPI), more sensitivity at KPI and service levels, and more easily able to be manipulated through machine learning.

There is included a method and apparatus comprising memory configured to store computer program code and a processor or processors configured to access the computer program code and operate as instructed by the computer program code. The computer program code includes providing code configured to cause the at least one processor to provide networked services to a customer, measuring code configured to cause the at least one processor to measure a plurality of key performance indicators (KPIs) representing qualities of provision of the services to the customer, obtaining code configured to cause the at least one processor to obtain, in response to obtaining the KPIs, one or more dynamic KPI weights based on classifications of the KPIs as indicated by pre-stored information based on at least a first cluster of first customers in which the customer is preassigned, normalizing code configured to cause the at least one processor to normalize values indicated by the KPIs and separating the normalized values into at least a first group and a second group based on priority information for each of the KPIs as indicated by the pre-stored information, training code configured to cause the at least one processor to obtain a plurality of customer experience indicators (CEIs) by averaging the normalized values of the KPIs per group and scaling the averaged values of each group by respective ones of the dynamic KPI weights indicated by the pre-stored information, determining code configured to cause the at least one processor to determine whether the CEIs indicate that at least one of the services affects an overall CEI more than another one of the services, and changing code configured to cause the at least one processor to change the customer from the first cluster of first customers to a second cluster of second customers based on which of the at least one of the services affects the overall CEI more than the other one of the services such as based on at least one of the KPIs.

According to exemplary embodiments, the first cluster comprises first rankings of the services that is different than second rankings of the services of the second cluster.

According to exemplary embodiments, the first rankings indicate the one or more dynamic KPI weights of the services,

According to exemplary embodiments, the second rankings indicate second one or more dynamic KPI weights of the services different than one or more dynamic KPI weights of the services as indicated by the first rankings.

According to exemplary embodiments, changing the customer from the first cluster to the second cluster comprises determining whether the customer used a first one of the services more than a second one of the services over a time period.

According to exemplary embodiments, the second service comprises a higher rank in the second cluster than does the first service in the first cluster such that the higher rank indicates a greater dynamic weighting of that second service in the second cluster than for the first service in the second cluster.

According to exemplary embodiments, the first customers of the first cluster are predetermined as using the one or more services at a first similar rate over a previous time period, and the second customers of the second cluster are predetermined as using the one or more services at a second similar rate over the previous time period.

According to exemplary embodiments, changing the customer from the first cluster to the second cluster is further based whether the customer issued a complaint about the second service.

According to exemplary embodiments, changing the customer from the first cluster to the second cluster comprises changing the customer from the first cluster to the second cluster based on the customer issuing the complaint regardless of whether the customer used the second service at a higher rate than the first service over the time period.

According to exemplary embodiments, after changing the customer from the first cluster to the second cluster, there is further determining a lowest CEI of the CEIs for the customer and automatically controlling at least one of issuance of a ticket for the customer based on the lowest CEI and forming a connection between the customer and a help desk representative.

### BRIEF DESCRIPTION OF THE DRAWINGS

Further features, nature, and various advantages of the disclosed subject matter will be more apparent from the following detailed description and the accompanying drawings in which:

FIG. 1 is a simplified schematic illustration in accordance with embodiments.

FIG. 2 is a simplified block diagram in accordance with embodiments.

FIG. 3A is a simplified graph in accordance with embodiments.

FIG. 3B is a simplified graph in accordance with embodiments.

FIG. 4 is a simplified block diagram in accordance with embodiments.

FIG. 5 is a simplified flow chart in accordance with embodiments.

FIG. 6 is a simplified block diagram in accordance with embodiments.

FIG. 7 is a simplified block diagram in accordance with embodiments.

FIG. 8 is a simplified block diagram in accordance with embodiments.

FIG. 9 is a simplified block diagram in accordance with embodiments.

FIG. 10 is a simplified block diagram in accordance with embodiments.

FIG. 11 is a block diagram of internal and external components of computers and servers depicted in FIG. 1 in accordance with embodiments.

FIG. 12 is a block diagram of an illustrative cloud computing environment including the computer system depicted in FIG. 1 in accordance with embodiments.

FIG. 13 is a block diagram of functional layers of the illustrative cloud computing environment of FIG. 12 in accordance with embodiments.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

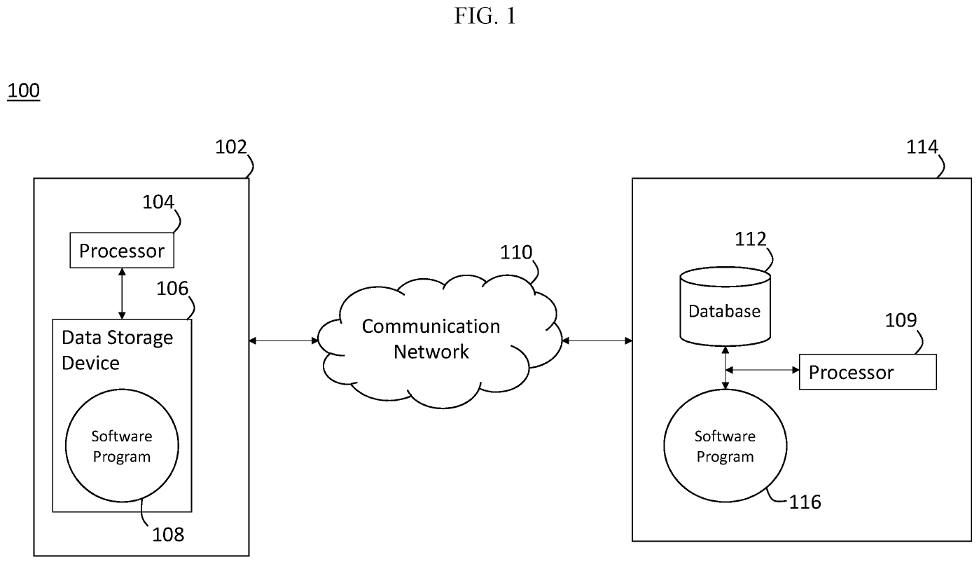

Referring now to FIG. 1, a functional block diagram of a networked computer environment illustrating a system 100 (hereinafter “system”) is provided. It should be appreciated that FIG. 1 provides only an illustration of one implementation and does not imply any limitations with regard to the environments in which different embodiments may be implemented. Many modifications to the depicted environments may be made based on design and implementation requirements.

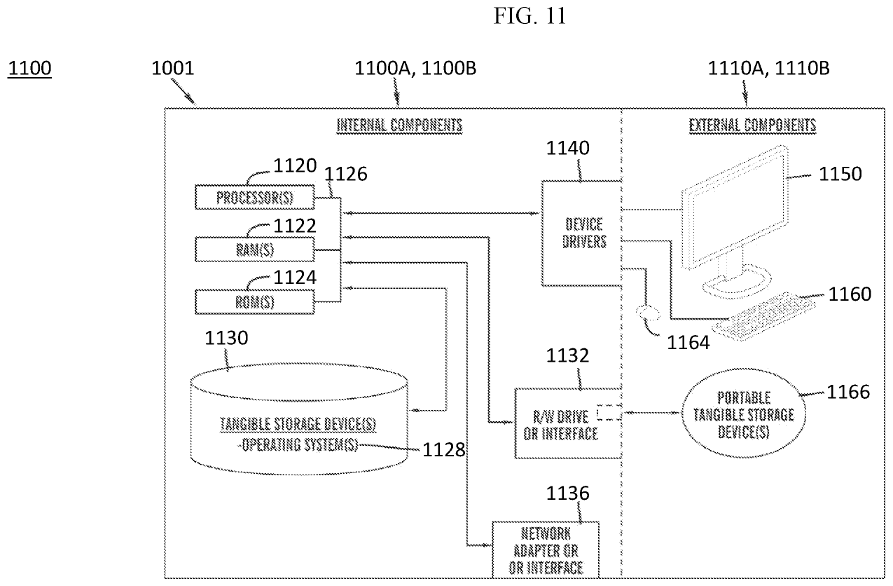

The system 100 may include a computer 102 and a server computer 114. The computer 102 may communicate with the server computer 114 via a communication network 110 (hereinafter “network”). The computer 102 may include a processor 104 and a software program 108 that is stored on a data storage device 106 and is enabled to interface with a user and communicate with the server computer 114. As will be discussed below with reference to FIGS. 11, 12, and 13 the computer 102 may include internal components and external components, respectively, and the server computer 114 may also include internal components and external components, respectively. The computer 102 may be, for example, a mobile device, a telephone, a personal digital assistant, a netbook, a laptop computer, a tablet computer, a desktop computer, or any type of computing devices capable of running a program, accessing a network, and accessing a database.

The server computer 114 may also operate in a cloud computing service model, such as Software as a Service (SaaS), Platform as a Service (PaaS), or Infrastructure as a Service (IaaS), as discussed below with respect to FIGS. 11, 12, and 13. The server computer 114 may also be located in a cloud computing deployment model, such as a private cloud, community cloud, public cloud, or hybrid cloud.

The server computer 114, which may be used for developing customer experience indicators Software Program 116 (hereinafter “program”), as implemented by the processor 109, that may interact with a database 112 as explained more fully below. According to exemplary embodiments, the computer 102 may operate as an input device according to its software program 108 including a user interface while the program 116 may run primarily on the server computer 114. In an alternative embodiment, the program 116 may run primarily on one or more computers 102 while the server computer 114 may be used for processing and storage of data used by the program 116. According to another embodiment, the program 116 may run on one or more computers 102 and data used by the program 116 may be stored in the one or more computers 102. In this case, the server computer 114 may be omitted. It should be noted that the program 116 may be a standalone program or may be integrated into another program.

Further, it should be noted that processing for the program 116 may, in some instances, be shared amongst the computers 102 and the server computers 114 in any ratio. In another embodiment, the program 116 may operate on more than one computer, server computer, or some combination of computers and server computers, for example, a plurality of computers 102 communicating across the network 110 with a single server computer 114. In another embodiment, for example, the program 116 may operate on a plurality of server computers 114 communicating across the network 110 with a plurality of client computers. Alternatively, the program may operate on a network server communicating across the network with a server and a plurality of client computers.

The network 110 may include wired connections, wireless connections, fiber optic connections, or some combination thereof. In general, the network 110 can be any combination of connections and protocols that will support communications between the computer 102 and the server computer 114. The network 110 may include various types of networks, such as, for example, a local area network (LAN), a wide area network (WAN) such as the Internet, a telecommunication network such as the Public Switched Telephone Network (PSTN), a wireless network, a public switched network, a satellite network, a cellular network (e.g., a fifth generation (5G) network, a long-term evolution (LTE) network, a third generation (3G) network, a code division multiple access (CDMA) network, etc.), a public land mobile network (PLMN), a metropolitan area network (MAN), a private network, an ad hoc network, an intranet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of system 100 may perform one or more functions described as being performed by another set of devices of system 100.

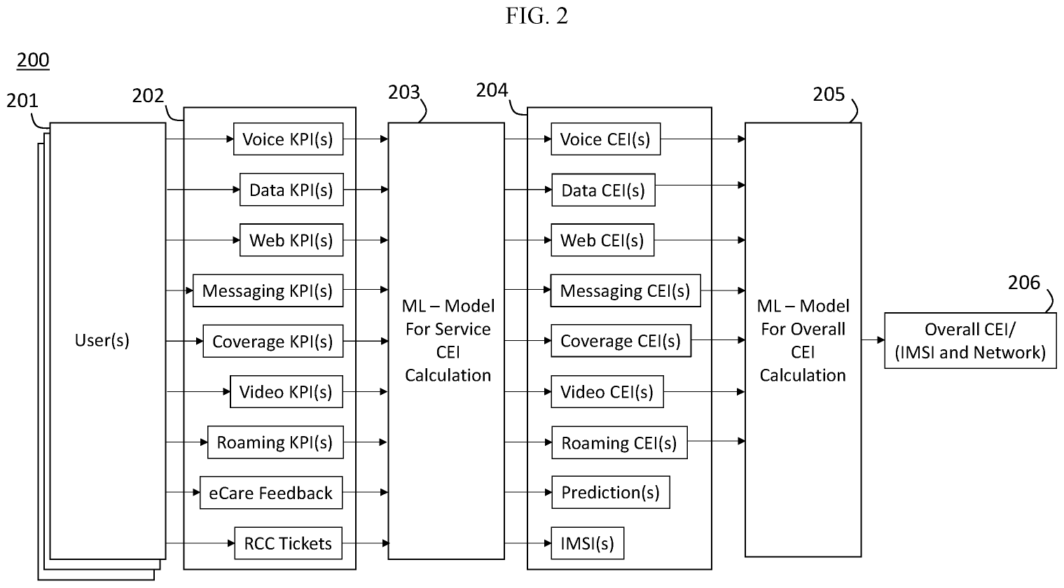

FIG. 2 illustrates a simplified block diagram 200 according to exemplary embodiments representing aspects of one or more neural networks that may advantageously monitor network communication conditions as described further below.

For example, one or more of user devices 201 may be using one of more services each of which may provide one or more key performance indicators (KPIs) that may be compared with statistical values across a network of such services as experiences by other users as described more fully below. Such information 202 may be transmitted to a machine learning (ML) network 203 for modeling various collection effectiveness indices (CEIs), outputs of such network 203 may be provided, as data 204, including any of the CEIs, predictions, and international mobile subscriber identity (IMSI) information, to another ML model network 205 for an overall CEI calculation which may be output as an overall CEI 206 to the ML network 203 thereby continuously improving the accuracy of various network metrics and more accurately reflecting customer experiences as will be more fully understood in view of the below descriptions. As discussed below, such information is also utilized to generate and adjust users with respect to various clusters thereby representing a technical advantage that may allow for identification of various user(s) and their experiences with respect to one or more of the KPIs, which may be many more than illustrated in FIG. 2, per any time unit according to exemplary embodiments.

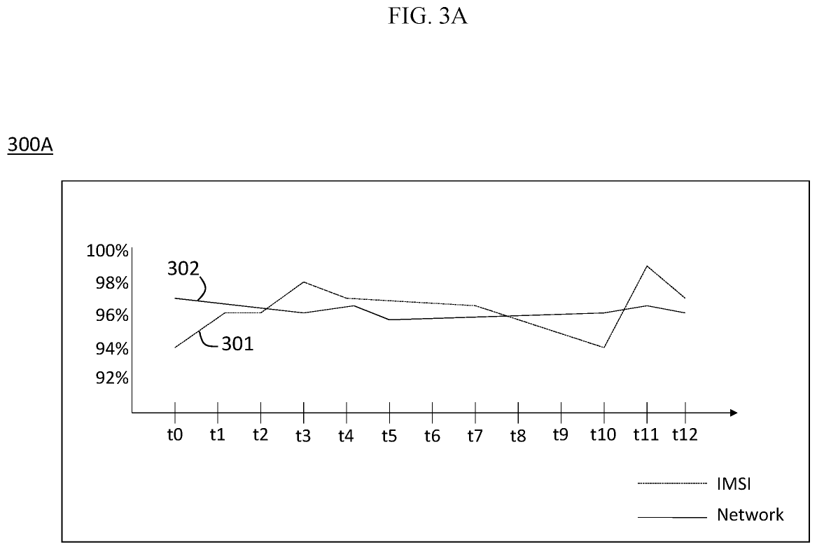

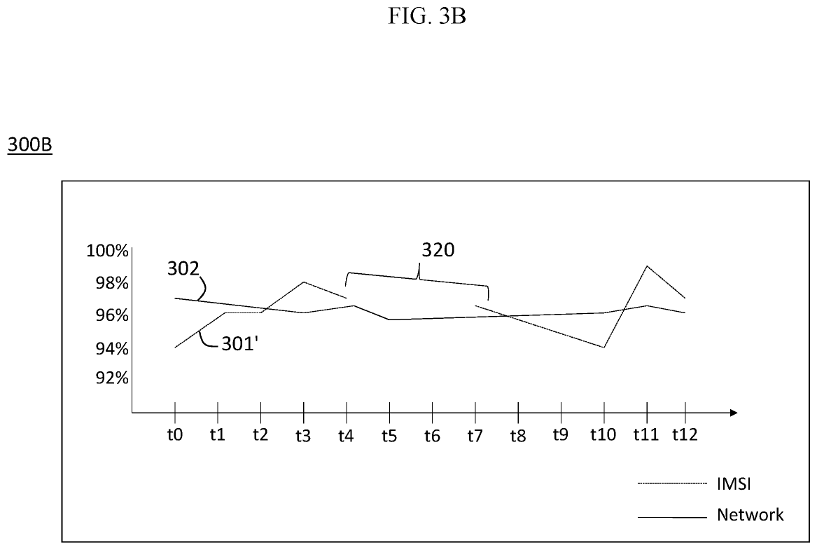

According to exemplary embodiments, FIG. 3A illustrates an exemplary table 300A of one of the many data which may be input with information 202 of FIG. 2. For example, as a user 201 uses a service, for example video, such information is recorded and compared with respect to a statistical value of quality of network delivery of that service across a larger portion of the network and up to the whole network. For example, according to such example table 300A, it is apparent that there are fluctuations across times t0-t12 between a quality 301 of video service to a particular IMSI as compared to a statistical value, such as an average, of such video service, of delivery of that video service as quality 302. As in FIG. 3A, at time t10, the quality 301 of the service to the IMSI is lower than the quality 302 across the network, and as such, if a user corresponding to that IMSI were to complain about a problem with a service at t10, then it may be confirmed whether that user is experiencing some service quality relative to that of the network. As described below, such information may factor into creating of weights in the various machine learning models thereby improving the accuracy of predicting various network characteristics, even at the individual user level. If the data in FIG. 3A represents one or more instances of a specific user using said server, such as video for example, then depending on various thresholds such information may be used to classify that instance as either positive or negative with varying degrees in deciding whether to move the user from one cluster to another at any given moment. Further, such different clusters may include different weights with respect to such performance indicators as illustrated in FIG. 3A as to whether to more or less heavily weight said information as one or more degrees of positive and negative affect to any particular user experience and/or cluster of users' experiences according to exemplary embodiments.

Further, in the exemplary embodiments illustrated with respect to FIG. 3A, the exemplary table 300B illustrates the quality 302 for such service, for example the video service as in FIG. 3A, but, from about time t4 to time t7, the specific user of that IMSI was not using such service, and accordingly, there is a gap 320 which may be further accounted in determining whether and how to weight this particular user's service information in the various machine learning models as described further below.

It will be understood that the percentages illustrated in FIGS. 3A and 3B may represent a quality of a CEI and the times may be taken periodically, such as daily, but of course, other periods are within the scope of the disclosure, such as hours, minutes, seconds, weeks, etc.

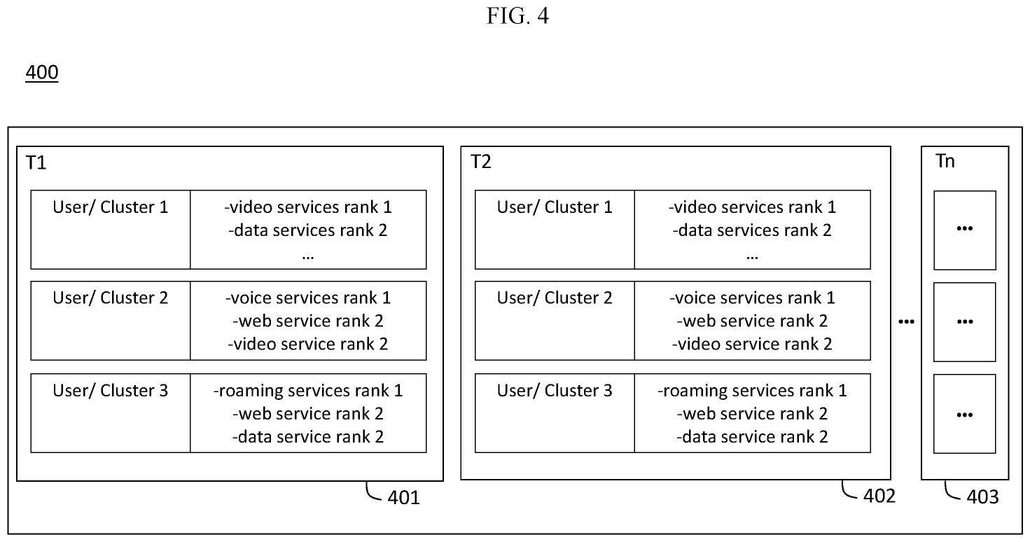

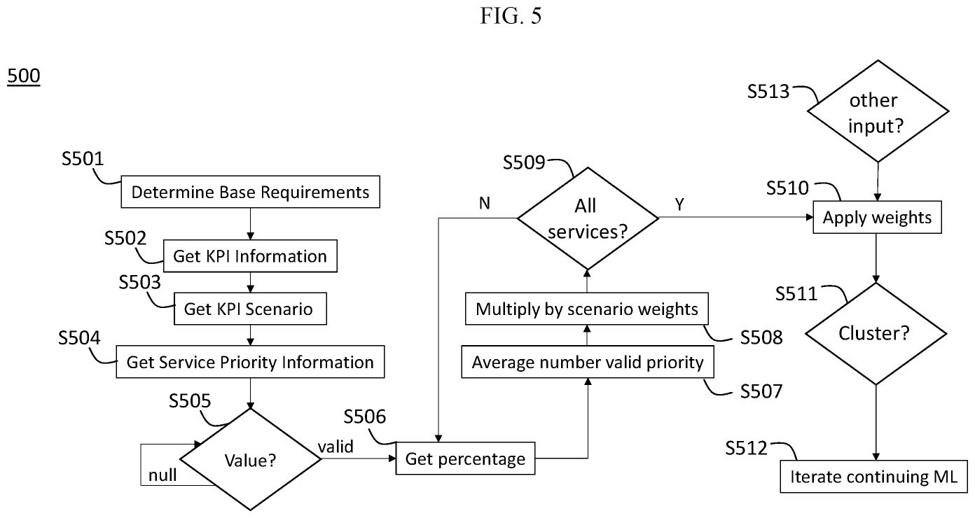

FIG. 4 illustrates an exemplary block diagram 400 as a timeline among times T1 401, T2 402, and Tn 403. For example, as shown at T1 401, there may be multiple clusters, such as cluster 1, cluster 2, and cluster 3 where each cluster may contain therein multiple users most closely corresponding to one of more of a plurality of the ranks. For example, if a user at T1 more closely aligns with usage and performances of services such that the video services has a rank 1 and a data services has a rank 2, then such information would be used to classify that user in cluster 1; that is, if, at T1 401, the user had used more video than data and more data than other services with some performances, described more fully throughout this disclosure, then that user would be found to have ranks of services corresponding to cluster 1. Also, many other users may also be in cluster 1 as also having corresponding ranks per that unit of time T1 401. Similarly, each of cluster 2 and cluster 3 may also have users respectively corresponding to the various services usages and ranks/performances thereof as shown at T1 401. Additionally, each of the clusters may include respective weights for each of the services where the calculations described below with respect to at least FIG. 5 for example will be weighted differently, or at least partly differently, depending on which cluster which user is in at any given time, such as at time T1.

Additionally, at a next time point, such as T2 at 402, there may be a reevaluation for one or more of the users such that if the user described above from cluster 1 had, for example, used services more closely corresponding to ones of cluster 2 or cluster 3, such as by using more voice or roaming services with some performance quality for example, then it may be determined to move that user to a corresponding one of the cluster 2 or cluster 3 so as to better represent an actual experience of the user regardless of whether the user makes an actual complaint or ticketing request regarding some performance metric. As described below in FIG. 5, additionally, whether a user makes a request, such as a help desk ticketing issue, regarding a service that is not consistent with the user's cluster at some time, then that additional information may also be used when deciding whether to move the user from one cluster to another. Additionally, the process may continue for each one or more user for each cluster per any unit of time such as also at time Tn 403. Of course, the above clusters and service rankings are merely exemplary embodiments and may include may different orderings, rankings, and permutations thereof. Such information may also be used to automatically generate such ticket and/or automatically connect a help desk representative to the customer in attempt to rectify any possible issues that the customer may experience; for example, by determining a lowest CEI or a CEI below some threshold according to exemplary embodiments, then such features may be automatically activated thereby improving over technical problems in the network.

According to exemplary embodiments, such logic will be running over every time stamp, such as T1 401, T2 402, and Tn 403 (where one or more time stamps may be between T2 402 and Tn 403), so as to keep dynamically changing weights per service and per kpi based on an actual used service per user. As such, at every time stamp, such as ones of the times T1 401, T2 402, and Tn 403, the user can move between different clusters, and the clusters themselves may be evaluated and recreated at every such time stamp. Service rankings may be assigned per user/cluster based on at least any of (a) a service traffic volume, (b) a throttling status, (c) an RAT access such as one of 2G/3G/4G/5G, and (d) a BSS profile, such as a subscription profile. For example, if a first user had Data Service “within one Time Stamp” and experience 2 handovers and 8 session setup then session setup KPI will be W1 and handover KPI will be W2 where W1>W2 and all weights value will be based on the available KPIs within this time Stamp, T1 401, according to exemplary embodiments. Additionally for example, if a second user in the first time stamp, T1 401, did Voice service and at a second time stamp, T2 402, had no voice services but only had video and messages services, then the weights per that user will be dynamically assigned according to exemplary embodiments such as per the tables below, such as Table 1:

TABLE 1

| User 1 | User 2 | Video | Message |
|---|---|---|---|
| Time Stamp 1 | High Weight | Low Weight | Low Weight |
| Time Stamp 2 | Low Weight | High Weight | High Weight |

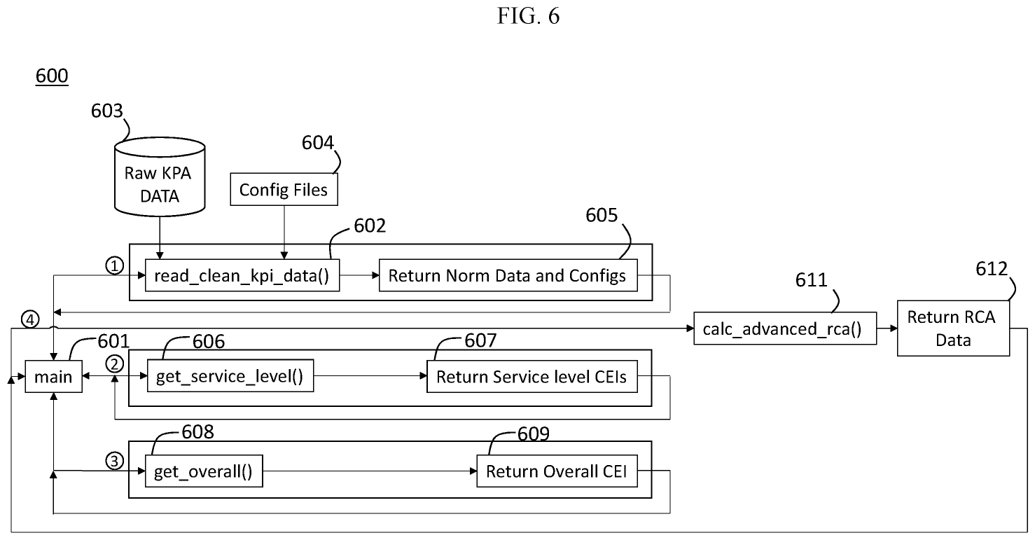

FIG. 5 illustrates an exemplary flow chart 500, including features described more fully below with respect to the accompanying tables and FIGS. 6, 7, 8, and 9. According to exemplary embodiments, the below tables 1A-6 may be considered as snapshots at any moment in time for one or more users and or user clusters and are subject to dynamically change as described below.

At S501, a processor implements a program to determine, based on predefined parameters and/or current user inputs, base requirements such as determining which services (e.g., data, voice, messaging, web, video, coverage . . . etc) may be used in the machine learning, which KPI may be most relevant to each service determined to be used in the machine learning as well as determining a KPI service and category, thresholds/legends for each KPI, priorities for each KPI and for each Service, and to determine weights for each priority on both a service CEI level and an overall CEI level calculation.

After setting the base requirements, at S502, the processor may create one or more required tables, such as a KPI information table with thresholds/legends, such as illustrated below with respect to the exemplary Table 1A and Table 1B which may be included as a single table but are divided here for clarity of illustration:

TABLE 1A

| KPI [symbol] | SERVIC [symbol] | SEVER [symbol] | WORS [symbol] | BEST [symbol] | USE LEGEN |
|---|---|---|---|---|---|
| Coverage_Radio_Quality_ratio_avg_RSRQ | Coverage | High | 1 | 0 | FALSE |
| Coverage_Ratio_of_5_second_intervals_with_Avg_RSRP_It_minus_116 | Coverage | High | 1 | 0 | FALSE |
| Coverage_Ratio_of_5_second_intervals_with_Max_RSRP_It_minus_116 | Coverage | High | 1 | 0 | FALSE |
| Coverage_TAU_SR | Coverage | High | 0 | 1 | FALSE |
| Data_Accessibility_Success_Ratio | Data | High | 0 | 1 | FALSE |
| Data_Average_HTTP_Packet_loss_Ratio | Data | High | 1 | 0 | FALSE |
| Data_Mean_Throughput_DL_Kbps | Data | High | 0 | 10000 | TRUE |
| Data_Mean_Throughput_UL_Kbps | Data | High | 0 | 5000 | TRUE |
| Data_Median_Intemet_Latency_mSec | Data | High | 300 | 50 | TRUE |
| Data_Median_Ran_Latency_mSec | Data | Medium | 500 | 100 | TRUE |
| Data_Median_RTT_mSec | Data | High | 500 | 100 | TRUE |
| Data_Mobility_Success_Ratio | Data | High | 0 | 1 | FALSE |
| Data_Paging_SR | Data | High | 0 | 1 | FALSE |
| Data_Retainability_Success_Ratio | Data | High | 0 | 1 | FALSE |
| Data_S1AP_Attach_Success_Ratio | Data | High | 0 | 1 | FALSE |
| Messaging_MO_SMS_SIP_Success_Ratio | Messaging | High | 0 | 1 | FALSE |
| Messaging_MT_SMS_SR | Messaging | High | 0 | 1 | FALSE |
| Roaming_Average_vMOS | Roaming | High | 1 | 5 | TRUE |
| Roaming_Avg_RTT_mSec | Roaming | Low | 1000 | 500 | TRUE |
| Roaming_Create_Session_Success_Ratio | Roaming | High | 0 | 1 | FALSE |
| Roaming_Intemet_QoE | Roaming | High | 0 | 1 | FALSE |
| Roaming_Update_Location_Success_Ratio | Roaming | High | 0 | 1 | FALSE |
| Video_Average_of_Video_Streaming_Stall | Video | High | 15 | 0 | TRUE |
| Video_Average_Playout_VMOS_Score | Video | High | 1 | 4 | TRUE |
| Video_Avg_OF_Streaming_packet_loss_Rate | Video | Medium | 1 | 0 | FALSE |
| Video_Avg_of_Streaming_Throughput | Video | Medium | 1000 | 10000 | TRUE |
| Video_Median_Video_Streaming_Start_Delay_mSec | Video | Medium | 5000 | 1000 | FALSE |
| Video_Streaming_Play_Disconnection_SR | Video | Medium | 0 | 1 | FALSE |
| Video_Streaming_Start_Success_Ratio | Video | High | 0 | 1 | FALSE |
| Voice_Average_Voice_pMOS | Voice | High | 1 | 5 | TRUE |
| Voice_Average_VoLTE_Jitter | Voice | High | 25 | 5 | TRUE |
| Voice_Avg_VoLTE_Packet_Loss_Ratio | Voice | High | 1 | 0 | FALSE |
| Voice_Call_Setup_Success_Ratio | Voice | High | 0 | 1 | FALSE |
| Voice_Handover_interruption_time | Voice | High | 1500 | 0 | TRUE |
| Voice_IMS_Registration_SR | Voice | High | 0 | 1 | FALSE |
| Voice_MO_Call_setup_time | Voice | High | 10 | 2 | TRUE |
| Voice_MT_Call_setupvtime | Voice | High | 10 | 2 | TRUE |
| Voice_RCS_Call_Drop_Ratio | Voice | High | 1 | 0 | FALSE |
| Voice_RCS_Registration_SR | Voice | High | 0 | 1 | FALSE |
| Voice_VoLTE_Call_Drop_Ratio | Voice | High | 1 | 0 | FALSE |
| Voice_X2_HO_SR | Voice | High | 0 | 1 | FALSE |
| Web_Browsing_Success_Ratio | Web | Medium | 0 | 1 | FALSE |
| Web_Browsing_TTFB_mSec | Web | High | 5000 | 500 | FALSE |
| Web_Response_Delay | Web | High | 1000 | 65 | TRUE |
| Web_Response_SR | Web | High | 0 | 1 | FALSE |

TABLE 1B

| Range1 | Value1 | Range2 | Value2 | Range3 | Value3 | Range4 | Value4 | Range5 | Value5 |
|---|---|---|---|---|---|---|---|---|---|
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| >10000 | 1 | 5000-1000 | 0.8 | 3000-5000 | 0.6 | 1000-3000 | 0.3 | <1000 | 0 |
| >5000 | 1 | 2000-5000 | 0.8 | 1000-2000 | 0.6 | 500-1000 | 0.3 | <500 | 0 |
| <50 | 1 | 50-100 | 0.8 | 100-200 | 0.6 | 200-300 | 0.3 | >300 | 0 |
| <100 | 1 | 100-150 | 0.8 | 150-200 | 0.6 | 200-500 | 0.3 | >500 | 0 |
| <100 | 1 | 100-150 | 0.8 | 150-200 | 0.6 | 200-500 | 0.3 | >500 | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| >4 | 1 | 3-4 | 0.8 | 2-3 | 0.6 | 1-2 | 0.3 | <1 | 0 |
| <500 | 1 | 500-600 | 0.8 | 600-700 | 0.6 | 700-1000 | 0.3 | >1000 | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| 0-3 | 1 | 3-5 | 0.8 | 2-3 | 0.6 | 3-10 | 0.3 | >10 | 0 |
| >4 | 1 | 3-4 | 0.8 | 2-3 | 0.6 | 1-2 | 0.3 | <1 | 0 |
| | 1 | | 0.8 | | 0.6 | | 0.3 | | 0 |
| >10000 | 1 | 5000-1000 | 0.8 | 3000-5000 | 0.6 | 1000-3000 | 0.3 | <1000 | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| >3.5 | 1 | 3-3.5 | 0.8 | 2-3 | 0.6 | 1.5-2 | 0.3 | <1.5 | 0 |
| <5 | 1 | 5-10 | 0.8 | 10-15 | 0.6 | 15-25 | 0.3 | >25 | 0 |
| | 1 | | 0.8 | | 0.6 | | 0.3 | | 0 |
| | 1 | | 0.8 | | 0.6 | | 0.3 | | 0 |
| <300 | 1 | 300-500 | 0.8 | 500-1000 | 0.6 | 1000-1500 | 0.3 | >1500 | 0 |
| | 1 | | 0.8 | | 0.6 | | 0.3 | | 0 |
| <2.5 | 1 | 2.5-3 | 0.8 | 5-7.5 | 0.6 | 7.5-10 | 0.3 | >10 | 0 |
| <2 | 1 | 2-3 | 0.8 | 3-5 | 0.6 | 5-10 | 0.3 | >10 | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| | 1 | | 0.8 | | 0.6 | | 0.3 | | 0 |
| <50 | 1 | 50-150 | 0.8 | 150-250 | 0.6 | 250-500 | 0.3 | >500 | 0 |
| | 1 | | 0.8 | | 0.6 | | 0.3 | | 0 |

The Tables 1A and 1B (herein collectively “Table 1,” as such Tables 1A and 1B may be combined), may be based on predetermined or currently input values by a user and are subject to dynamic change depending on results of the machine learning as iterated through the steps of exemplary flowchart 500 for example.

At S503, the processor may continue creating required tables by, for example, creating a KPI scenario Table, such as the following Table 2:

TABLE 2

| | | | | | | | | | | |
|---|---|---|---|---|---|---|---|---|---|---|
| Scenario Name | Name1 | Rank 1 | Name2 | Rank2 | Name3 | Rank3 | Name4 | Rank4 | Name5 | Rank5 |

| | | | | | | |
|---|---|---|---|---|---|---|
| All | High | 0.7 | Medium | 0.2 | Low | 0.1 |
| High | High | 1 | | | | |
| Medium | Medium | 1 | | | | |
| Low | Low | 1 | | | | |
| HighMedium | High | 0.78 | Medium | 0.22 | | |
| HighLow | High | 0.875 | Low | 0.125 | | |
| MediumLow | Medium | 0.67 | Low | 0.33 | | |

Additionally, the values of Table 2 are dynamically editable, including number/names of scenarios, ranks, and values of each. Further, exemplary embodiments may use the following formula of Table 3 to determine each scenario weight based on an available KPI of certain priorities:

TABLE 3

| | | | |
|---|---|---|---|
| High | 70% | 70% | 70% |
| medium | 20% | null | 20% |
| low | 10% | 10% | null |
| sum of weights | 100% | 80% | 90% |
| remaining weight | 0% | 20% | 10% |
| high | 70% | 70% + (70/80) * 20% = 87.5% | 70% + (70/90) * 10% = 77.77% |
| medium | 20% | 0% | 20% + (20/90) * 10% = 22.22% |
| low | 10% | 10% + (10/80) * 20% = 12.5% | 0 |

Similarly to S502, at S503, the processor may also continue creating required tables by, for example, creating an overall scenario table, such as the following Table 4:

TABLE 4

| | | | | | | | | | | |
|---|---|---|---|---|---|---|---|---|---|---|
| Scenario Name | Name1 | Rank 1 | Name2 | Rank2 | Name3 | Rank3 | Name4 | Rank4 | Name5 | Rank5 |

| | | | | | | |
|---|---|---|---|---|---|---|
| All | High | 0.7 | Medium | 0.2 | Low | 0.1 |
| High | High | 1 | | | | |
| Medium | Medium | 1 | | | | |
| Low | Low | 1 | | | | |
| HighMedium | High | 0.78 | Medium | 0.22 | | |
| HighLow | High | 0.875 | Low | 0.125 | | |
| MediumLow | Medium | 0.67 | Low | 0.33 | | |

Additionally, the values of Table 4 are dynamically editable, including number/names of scenarios, ranks, and values of each. Further, exemplary embodiments may use the following formula of Table 5 to determine each scenario weight based on an available KPI of certain priorities:

TABLE 5

| | | | |
|---|---|---|---|
| High | 70% | 70% | 70% |
| medium | 20% | null | 20% |
| low | 10% | 10% | null |
| sum of weights | 100% | 80% | 90% |
| remaining weight | 0% | 20% | 10% |
| high | 70% | 70% + (70/80) * 20% = 87.5% | 70% + (70/90) * 10% = 77.77% |
| medium | 20% | 0% | 20% + (20/90) * 10% = 22.22% |
| low | 10% | 10% + (10/80) * 20% = 12.5% | 0 |

At S504, the processor may continue creating required tables by, for example, creating a service priority information table, such as the following Table 6:

TABLE 6

| SERVICE | SEVERITY |
|---|---|
| Data | High |
| Roaming | Ignored |
| Voice | High |
| Web | Low |
| Coverage | High |
| Messaging | Medium |
| Video | Low |

At S505, the processor may determine if a value is null or anomalous (based on predetermined or dynamic thresholds) and make said value as valid or invalid accordingly. For example, if valid, then at S506, the processor with use the KPI information sheet of Table 1 to turn said value into a percentage. For example, considering the Data_Mean_Throughput_DL_Kbps of Table 1, if the value is 8,500, then a normalized percentage will be 80%, and according to exemplary embodiments, such features must have an option to use minimum and maximum thresholds. For example, if such threshold is set 0-10,000 and a KPI value is 8,500, then the percentage may instead be 85%.

At S507, the processor may determine how many of each priority are valid and take an average from those found valid. For example, if there are found four valid high priority data KPI, three invalid high priority data KPI, zero invalid medium priority KPI, zero low priority KPI, and three invalid low priority KPI, then the processor may take the four valid data KPI normalized percentage values and take an average therefrom. For further example, for such high priority the normalized values could be 100%, 50%, 75%, and 30% for example and thus: (100%+50%+75%+30%)/4=63.75%, and for such medium priority the normalized values could be 75%, 10%, and 70% and thus: (75%+10%+70%)/3=51.67% with a scenario: high medium viewing the above tables and of course such examples are dependent upon the found values described above.

At S508, the processor may multiply said values from S507 by scenario weights. For example, with the above-noted high priority average=63.75% and the medium priority average=51.67%, then, viewing the above Tables, the high priority data value may be 63.75%*0.78=49.725%, the medium priority data value may be 51.67*0.22=11.367%, and the overall data CEI may be 61.092% (by addition of the found multiplication of said values from S507 by corresponding scenario weights). Such weighting is subject to dynamic change as described with respect to S509-S513.

At S509, the processor may determine if such S505, S506, S507, and S508 have been performed for all services such that scenario weights are multiplied by corresponding values. For example, considering the above Table 6, then there may be three high priority services: Data, Voice, and Coverage; zero medium priority services; 1 low priority service: video; and with a scenario of high low, then there may be found a Data CEI=70%, Voice CEI=30%, Web CEI=Null, Coverage CEI=100%, Messaging CEI=100%, and a Video CEI=90% such that: the high priority services=(Data CEI+Voice CEI+Coverage CEI)/3*0.875; medium priority services=null; low priority services=(Video CEI)*0.125; such that there are weights: high priority services=(70%+30%+100%)/3*0.875=46.7%; medium priority services=null; low priority services=(90%)/1*0.125=11.25%; and an Overall CEI may be 46.7%+11.25%=57.5%.

Such values may be taken with respect to any of Data-Mean Throughput DL (Kbps), Data-Mean Throughput UL (Kbps), Data-Median RTT mSec, Data-Median Internet Latency mSec, Data-Median Ran Latency mSec, Data-Mobility Success Ratio, Data-Accessibility Success Ratio, Data-Retainability Success Ratio, Data-Average HTTP Packet loss Ratio, Data-S1AP Attach Success Ratio, Roaming-Create Session Success Ratio, Roaming-Update Location Success Ratio, Roaming-Avg RTT mSec, Roaming-Internet QoE, Roaming-Average vMOS, Voice-VoLTE Call Drop Ratio, Voice-RCS Call Drop Ratio, Voice-Average Voice pMOS, Voice-IMS Registration SR, Voice-RCS Registration SR, Voice-Avg VoLTE Packet Loss Ratio, Voice-Average VoLTE Jitter, Video-Average Playout VMOS Score, Median Video Streaming Start Delay mSec, Video Streaming Start Success Ratio, Web Browsing TTFB (mSec), Web Browsing Success Ratio, MO SMS SIP Success Ratio, Data-Mean Throughput DL (Kbps), Data-Mean Throughput UL (Kbps), Data-Median RTT mSec, Data-Median Internet Latency mSec, Data-Median Ran Latency mSec, Data-Mobility Success Ratio, Data-Accessibility Success Ratio, Data-Retainability Success Ratio, Data-Average HTTP Packet loss Ratio, Data-S1AP Attach Success Ratio, Roaming-Create Session Success Ratio, Roaming-Update Location Success Ratio, Roaming-Avg RTT mSec, Roaming-Internet QoE, Roaming-Average vMOS, Voice-VoLTE Call Drop Ratio, Voice-RCS Call Drop Ratio, Voice-Average Voice pMOS, Voice-IMS Registration SR, Voice-RCS Registration SR, Voice-Avg VoLTE Packet Loss Ratio, Voice-Average VoLTE Jitter, Video-Average Playout VMOS Score, Median Video Streaming Start Delay mSec, Video Streaming Start Success Ratio, Web Browsing TTFB (mSec), Web Browsing Success Ratio, MO SMS SIP Success Ratio, Data-Mean Throughput DL (Kbps), Data-Mean Throughput UL (Kbps), Data-Median RTT mSec, Data-Median Internet Latency mSec, Data-Median Ran Latency mSec, Data-Mobility Success Ratio, Data-Accessibility Success Ratio, Data-Retainability Success Ratio, Data-Average HTTP Packet loss Ratio, Data-S1AP Attach Success Ratio, Roaming-Create Session Success Ratio, Roaming-Update Location Success Ratio Roaming-Avg RTT mSec, Roaming-Internet QoE, Roaming-Average vMOS, Voice-VoLTE Call Drop Ratio, Voice-RCS Call Drop Ratio, Voice-Average Voice pMOS, Voice-IMS Registration SR, Voice-RCS Registration SR, Voice-Avg VoLTE Packet Loss Ratio, Voice-Average VoLTE Jitter, Video-Average Playout VMOS Score, Median Video Streaming Start Delay mSec, Video Streaming Start Success Ratio, Web Browsing TTFB (mSec), Web Browsing Success Ratio, MO SMS SIP Success Ratio, Data High Priority Count, Data Medium Priority Count Data Low Priority Count, Voice High Priority Count, Voice Medium Priority Count, Voice Low Priority Count, Messaging High Priority Count, Messaging Medium Priority Count Messaging Low Priority Count, Video High Priority Count, Video Medium Priority Count, Video Low Priority Count, Web High Priority Count, Web Medium Priority Count, Web Low Priority Count, Web High Priority Count, Web Medium Priority Count, Web Low Priority Count, Data High Priority Percentage, Data Medium Priority Percentage, Data Low Priority Percentage, Data Priority Scenario, Voice High Priority Percentage, Voice Medium Priority Percentage, Voice Low Priority Percentage, Voice Priority Scenario, Messaging High Priority Percentage, Messaging Medium Priority Percentage, Messaging Low Priority Percentage, Messaging Priority Scenario, Video High Priority Percentage, Video Medium Priority Percentage, Video Low Priority Percentage, Video Priority Scenario, Web High Priority Percentage, Web Medium Priority Percentage, Web Low Priority Percentage, Web Priority Scenario, Roaming High Priority Percentage, Roaming Medium Priority Percentage, Roaming Low Priority Percentage, and Roaming Priority Scenario for example.

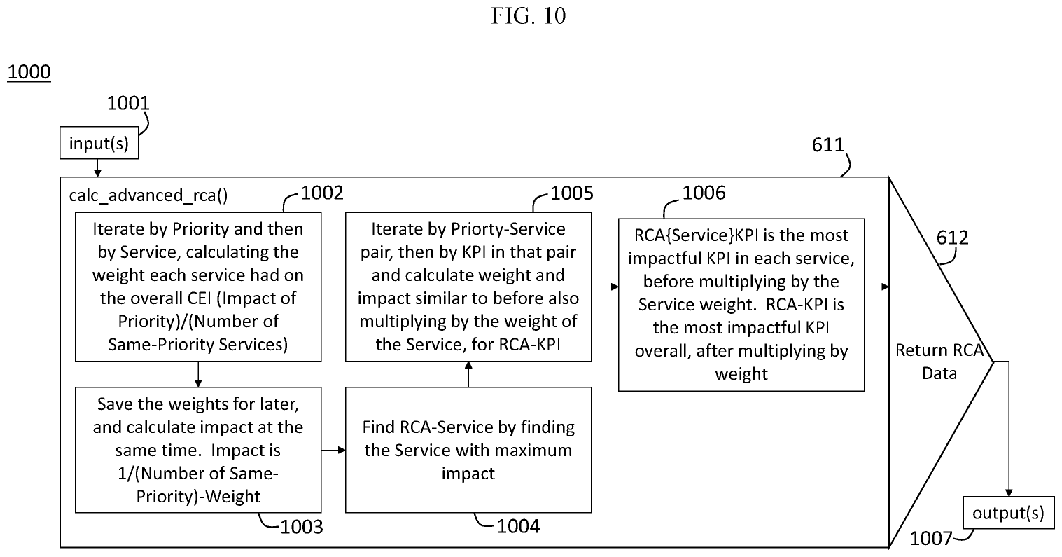

After S510, then the weights may be reapplied from the ML 203 and 205 of FIG. 2 as inputs into their neural networks. Further, at S511, it may be determined whether to recluster as described above with respect to FIG. 4 for one or more of the users and for one or more of the clusters, and also at S513 other input may also be accepted to more accurately reflect the dynamic weighting and clustering. For example, in the context of a user providing a voice complaint, such as by a help desk ticketing, then it may be determined whether the complaint is valid, such as by comparing a threshold level with respect to some actually recorded KPI for that service for that user even if not reflected in the CEI, and as such, the KPI may be optimized further, through the below reiteration, until the appropriate CEI is reflected, such as by matching a level reported by the customer; that is, a voice CEI may be increased relative to other CEI for that user. Such CEI may be with respect to any of the services described herein such as data, coverages, etc. among all the others noted herein. And at S512 the process reiterates, such as with respect to new input KPI data obtained, for example, at any of the intervals as described above with respect to FIGS. 3 and 4, and as further described with respect to FIGS. 6 and 10 below.

According to exemplary embodiments, FIGS. 6, 7, 8, and 9 further illustrate details with respect to FIGS. 2 and 5, and FIGS. 7, 8, and 9 each further illustrate details of FIG. 6 as described below.

For example, in FIG. 6, there is an exemplary diagram 600 including a main 601 from which the S501-S511 of FIG. 5 may be implemented as there is illustrated a read_clean_kpi_data( ) block 602, corresponding for example to data 202 of FIG. 2, a Return Norm Data and Configs block 605, get_service_level( ) block 606, a return service level CEIs block 607, a get_overall( ) block 608, and a return overall CEI block 609 corresponding to the steps of FIG. 5.

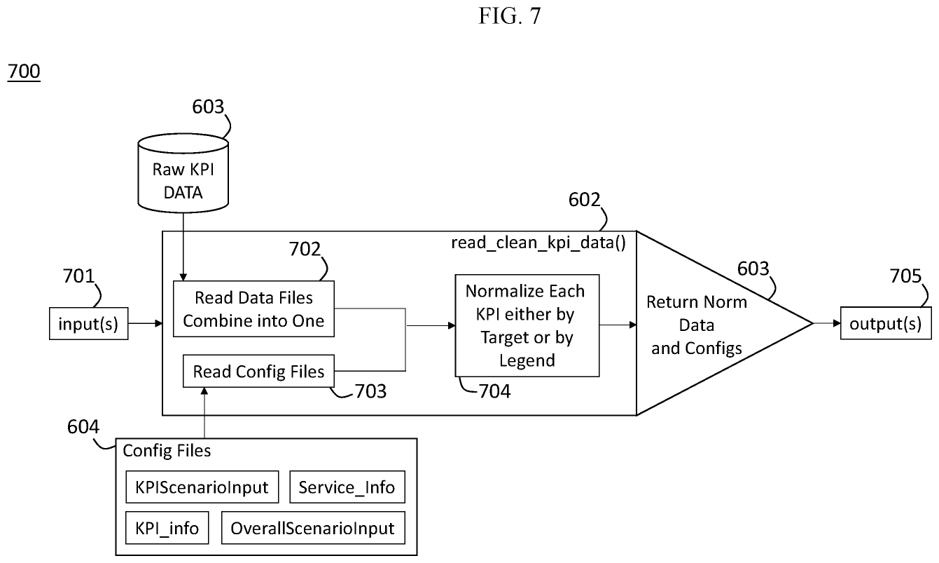

Viewing the read_clean_kpi_data( ) block 602 and return norm data and configs block 605 in the example diagram 700 in FIG. 7, it is shown that based on input instructions 701, the read_clean_kpi_data( ) block 602 represents instructions to the processor to obtain raw KPI data 603, such as data 202 in FIG. 2, as well as to read config files 604 which include various ones of the predetermined information described above and on which the read_clean_kpi_data( ) block 602 proceeds at least initially. The various data files from the raw KPI data 603 may be combined into a single file at block 702 and normalization may occur on each KPI as either by a target or by a legend at block 704. Such information is then returned at block 603 as outputs 705, and as seen in FIG. 6, such outputs 705 may feed back into any of main 601 and the read_clean_kpi_data( ) block 602.

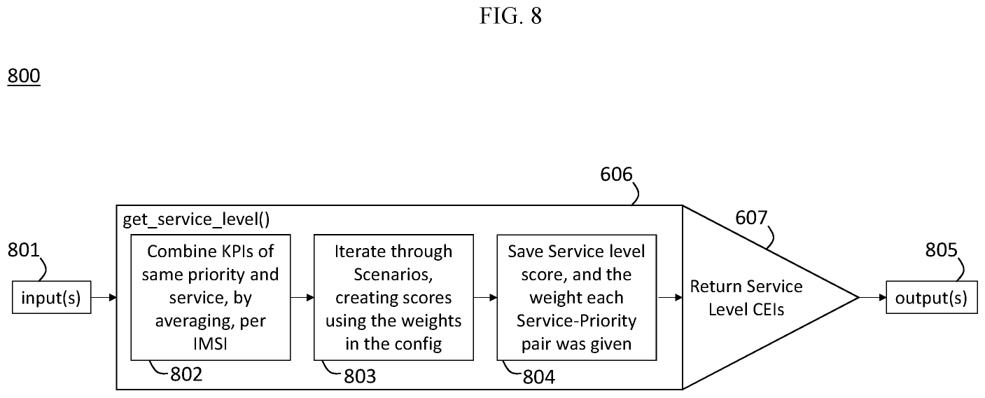

Viewing the example diagram 800 in FIG. 8, instruction inputs 801 may be provided to the get_service_level( ) 606 block which may cause the processor to implement combining, at block 802, ones of KPIs having a same priority and service, by averaging, per IMSI, and at block 803, to iterate through Scenarios, such as with creating scores using weights in the config, for example as described above with respect to FIG. 5, and similarly, at block 804, the processor may further implement saving a service level score, and a weight each service-priority pair may be given, and at the return service level CEIs block 607, various outputs 805 accordingly, may be provided back to any of the main 601 and to the get_service_level( ) block 606 in FIG. 6.

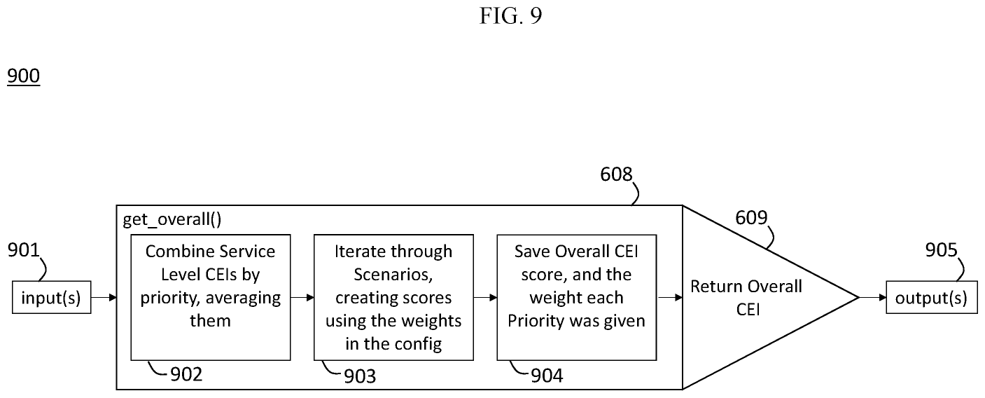

Viewing the example diagram 900 in FIG. 9, instruction inputs 901 may be provided to the get_overall( ) 608 block which may cause the processor to implement combining, at block 902, service level CEIs by priority, averaging them, and at block 903, to iterate through Scenarios, such as with creating scores using weights in the config, for example as described above with respect to FIG. 5, and similarly, at block 904, the processor may further implement saving an overall CEI, and a weight each priority may be given, and at the return Overall CEIs block 609, various outputs 905 accordingly may be provided back to any of the main 601 and to the get_overall( ) block 608 in FIG. 6.

Viewing the example diagram 1000 in FIG. 10, instruction inputs 1001 may be provided to the calc_advanced_rca( ) block 611 so as to control a processor to implement, at block 1002, iterating by priority, and then by service, a calculating of the weight each service had on the overall CEI data such as output at blocks 609 and 905, for example, by considering an (impact of priority)/(number of same-priority services). Further, at block 1003, the processor may implement saving the weights for later and calculating an impact at a same time such that an impact may be as shown in block 1003, and at block 1004, the processor may implement finding an RCA-service by finding a service having a maximum impact based on the calculations from block 1003. At block 1005, the processor may further implement iterating by a priority-service pair and then by KPI in that pair so as to then calculate a weight and impact similar to previous impacts as well as to also multiply by a weight of a Service, for RCA-KPI so that at block 1006 the processor may further obtain most impactful KPI in each service and also a most impactful KPI overall. Having a most impact indicates that such value is prone to cause a greatest shift among the other referenced values. Such information about most impactful KPIs may be returned at block 6612 as outputs 1007 to any of main 601 and also back into the calc_advanced_rca( ) block 611.

Accordingly, at bubble 1 in FIG. 6, the processor may read data and implement normalization, and dependent on the configuration sheets, may also either use target values or a legend to rate the values. At bubble 2 in FIG. 6, the processor may combine such normalized values by Service-Priority, and use Scenarios in config files to find Service-level CEI(s), and at bubble 3, the processor may combine such found Service-level CEI(s) into same Priority groups and use Scenarios in config to calculate an overall CEI. At bubble 4 in FIG. 6, the processor may further implement calculating an RCA, a most impactful element, for each row by backtracking and calculating a weight and impact that each service and each KPI had on an overall CEI and on each Service thereby yielding three kinds of RCA: RCA Service, RCA KPI for each Service and RCA KPI for the overall state. For example, such overall CEI may be found according to (in an exemplary case involving Data, Voice, Messaging, Web, Video, and Coverage services for example):

Overall CEI=(Average(NormalizedKPI_{Data})*SeverityWeight_{Data}*ServicePriority_{Data}))+((AverageNormalizedKPI_{Voice})*SeverityWeight_{Voice}*ServicePriority_{Voice}))+(Average(NormalizedKPI_{Messaging})*SeverityWeight_{Messaging}*ServicePriority_{Messaging}))+((Average(NormalizedKPI_{Web})*SeverityWeight_{Web}*ServicePriority_{Web}))+((Average(NormalizedKPI_{Video})*SeverityWeight_{Video}*ServicePriority_{Messaging}))+((Average(NormalizedKPI_{Coverage})*SeverityWeight_{Coverage}*ServicePriority_{Coverage})), and for example, a Roaming CEI=((Average(NormalizedKPI_{Roaming})*SeverityWeight_{Roaming}*ServicePriority_{Roaming})) according to exemplary embodiments.

As such, viewing the herein described exemplary embodiments, there are technical solutions to technical problems in network monitoring such that the embodiments described herein support features such that all priorities, weights, number of CEIs, number of KPIs, and number of CEI and KPI scenarios are freely editable at any time, all null values may be removed and not used in the equations, processing may only requires one KPI in a service to be able to provide a CEI for that service and an overall CEI, weights may be set once and can be applied to all KPIs rather than individual setting of every weight for every KPI and every CEI and will save a significant amount of time in initial setting and future adjustment, the exemplary features herein are also flexible so that if a KPI is not available it can still calculate the remainder accurately as for example, if the customer has not used data enough to be able to measure the DL throughput, but the RTT and other KPI are available, then the embodiments may mark the DL throughput KPI as invalid and not count it in the average calculation. This is also applicable to the overall CEI as if one service CEI is invalid, the in it is not calculated into the overall equation, and all parameters including thresholds, priorities, weights, and severities can be easily adjusted for sensitivity individually and will not require the reset of the entire equation. It is all calculated dynamically.

Further, such monitoring may be on the following scales according to various embodiments: hourly and daily CEI per service and overall CEI; providing a CEI per network, subscriber, device and roaming Operator; having a CEI provided in OSS CSV, QInsight dashboards and WebAPI; including use with a new QInsight CEI dashboard; may have a WebAPI last 7 day CEI per subscriber response time less than 2 seconds; all with advantages of scalable solutions for at least millions of subscribers.

According to embodiments herein, a CEI will be provided on any of a: per IMSI (coverage,data,Web,video) basis, a per calling/called party number (Messaging, VoLTE), an overall CEI per IMSI and calling/called party number (requires correlation) basis, a per roaming operator basis, a per device and device category basis, and a per location, network element (TBD) basis. Wherein aggregation, such as CEI aggregations will be created to provide fast CEI query time and to reduce DB load providing for each dimension (subscriber, device, roaming operator etc) with an aggregation granularity: hourly, daily for example.

FIG. 11 is a block diagram 1100 of internal and external components of computers depicted in FIG. 1 in accordance with an illustrative embodiment. It should be appreciated that FIG. 11 provides only an illustration of one implementation and does not imply any limitations with regard to the environments in which different embodiments may be implemented. Many modifications to the depicted environments may be made based on design and implementation requirements.

Computer 102 (FIG. 1) and server computer 114 (FIG. 1) may include respective sets of internal components 1100A,B and external components 1110A,B illustrated in FIG. 11. Each of the sets of internal components 1100 include one or more processors 1120, one or more computer-readable RAMs 1122 and one or more computer-readable ROMs 1124 on one or more buses 1126, one or more operating systems 1128, and one or more computer-readable tangible storage devices 1130.

Processor 1120 is implemented in hardware, firmware, or a combination of hardware and software. Processor 1120 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 1120 includes one or more processors capable of being programmed to perform a function. Bus 1126 includes a component that permits communication among the internal components 1100A,B.

The one or more operating systems 1128, the software program 108 (FIG. 1) and the Program 116 (FIG. 1) on server computer 114 (FIG. 1) are stored on one or more of the respective computer-readable tangible storage devices 1130 for execution by one or more of the respective processors 1120 via one or more of the respective RAMs 1122 (which typically include cache memory). In the embodiment illustrated in FIG. 11 each of the computer-readable tangible storage devices 1130 is a magnetic disk storage device of an internal hard drive. Alternatively, each of the computer-readable tangible storage devices 1130 is a semiconductor storage device such as ROM 1124, EPROM, flash memory, an optical disk, a magneto-optic disk, a solid state disk, a compact disc (CD), a digital versatile disc (DVD), a floppy disk, a cartridge, a magnetic tape, and/or another type of non-transitory computer-readable tangible storage device that can store a computer program and digital information.

Each set of internal components 1100A,B also includes a R/W drive or interface 1132 to read from and write to one or more portable computer-readable tangible storage devices 1166 such as a CD-ROM, DVD, memory stick, magnetic tape, magnetic disk, optical disk or semiconductor storage device. A software program, such as the software program 108 (FIG. 1) and the Program 116 (FIG. 1) can be stored on one or more of the respective portable computer-readable tangible storage devices 1136, read via the respective R/W drive or interface 1132 and loaded into the respective hard drive 1130.

Each set of internal components 1100A,B also includes network adapters or interfaces 1136 such as a TCP/IP adapter cards; wireless Wi-Fi interface cards; or 3G, 4G, or 5G wireless interface cards or other wired or wireless communication links. The software program 108 (FIG. 1) and the Program 116 (FIG. 1) on the server computer 114 (FIG. 1) can be downloaded to the computer 102 (FIG. 1) and server computer 114 from an external computer via a network (for example, the Internet, a local area network or other, wide area network) and respective network adapters or interfaces 1136. From the network adapters or interfaces 1136, the software program 108 and the Program 116 on the server computer 114 are loaded into the respective hard drive 1130. The network may comprise copper wires, optical fibers, wireless transmission, routers, firewalls, switches, gateway computers and/or edge servers.

Each of the sets of external components 1110A,B can include a computer display monitor 1150, a keyboard 1160, and a computer mouse 1164. External components 1110A,B can also include touch screens, virtual keyboards, touch pads, pointing devices, and other human interface devices. Each of the sets of internal components 1100A,B also includes device drivers 1140 to interface to computer display monitor 1150, keyboard 1160 and computer mouse 1164. The device drivers 1140, R/W drive or interface 1132 and network adapter or interface 1136 comprise hardware and software (stored in storage device 1130 and/or ROM 1124).

It is understood in advance that although this disclosure includes a detailed description on cloud computing, implementation of the teachings recited herein are not limited to a cloud computing environment. Rather, some embodiments are capable of being implemented in conjunction with any other type of computing environment now known or later developed.

A cloud computing environment is service oriented with a focus on statelessness, low coupling, modularity, and semantic interoperability. At the heart of cloud computing is an infrastructure comprising a network of interconnected nodes.

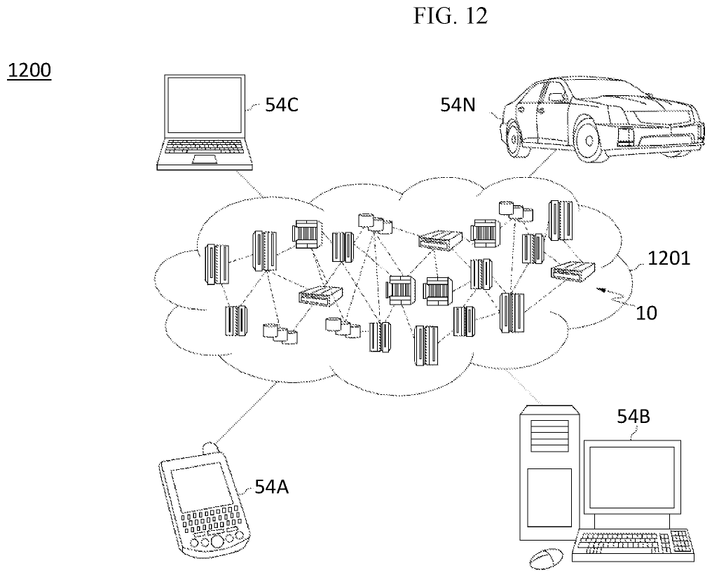

Referring to FIG. 12, illustrative cloud computing environment 1200 is depicted. As shown, cloud computing environment 1200 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 1200 to offer infrastructure, platforms and/or software as services for which a cloud consumer does not need to maintain resources on a local computing device. It is understood that the types of computing devices 54A-N shown in FIG. 12 are intended to be illustrative only and that cloud computing nodes 10 and cloud computing environment 1200 can communicate with any type of computerized device over any type of network and/or network addressable connection (e.g., using a web browser).

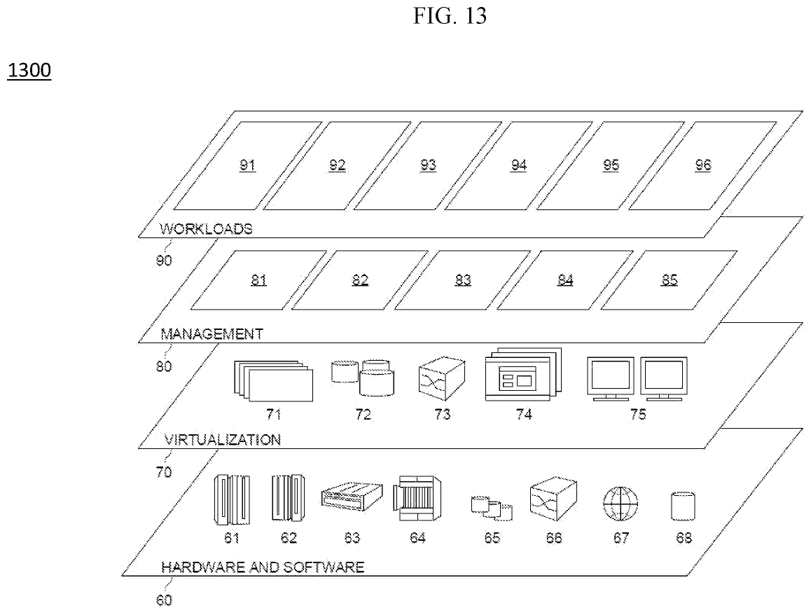

Referring to FIG. 13, a set of functional abstraction layers 1300 provided by cloud computing environment 1300 (FIG. 12) is shown. It should be understood in advance that the components, layers, and functions shown in FIG. 13 are intended to be illustrative only and embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA. Workloads layer 90 provides examples of functionality for which the cloud computing environment may be utilized.

Some embodiments may relate to a system, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing a network element, the method performed by at least one processor, comprising:
providing networked services to a customer;
measuring a plurality of key performance indicators (KPIs) representing qualities of provision of the services to the customer;
obtaining, in response to obtaining the KPIs, one or more dynamic KPI weights based on classifications of the KPIs as indicated by pre-stored information based on at least a first cluster of first customers in which the customer is preassigned;
normalizing values indicated by the KPIs and separating the normalized values into at least a first group and a second group based on priority information for each of the KPIs as indicated by the pre-stored information; and
training a machine learning model by changing the customer from the first cluster to a second cluster of second customers based on at least one of the KPIs.

2. The method according to claim 1, wherein the first cluster comprises first rankings of the services that is different than second rankings of the services of the second cluster.

3. The method according to claim 2, wherein the first rankings indicate the one or more dynamic KPI weights of the services,

4. The method according to claim 2, wherein the second rankings indicate second one or more dynamic KPI weights of the services different than one or more dynamic KPI weights of the services as indicated by the first rankings.

5. The method according to claim 4, wherein changing the customer from the first cluster to the second cluster comprises determining whether the customer used a first one of the services more than a second one of the services over a time period.

6. The method according to claim 1, wherein the second service comprises a higher rank in the second cluster than does the first service in the first cluster such that the higher rank indicates a greater dynamic weighting of that second service in the second cluster than for the first service in the second cluster.

7. The method according to claim 1, wherein the first customers of the first cluster are predetermined as using the one or more services at a first similar rate over a previous time period, and
wherein the second customers of the second cluster are predetermined as using the one or more services at a second similar rate over the previous time period.

8. The method according to claim 7, wherein changing the customer from the first cluster to the second cluster is further based whether the customer issued a complaint about the second service.

9. The method according to claim 8, wherein changing the customer from the first cluster to the second cluster comprises changing the customer from the first cluster to the second cluster based on the customer issuing the complaint regardless of whether the customer used the second service at a higher rate than the first service over the time period.

10. The method according to claim 1, further comprising:
obtaining a plurality of customer experience indicators (CEIs) by averaging the normalized values of the KPIs per group and scaling the averaged values of each group by respective ones of the dynamic KPI weights indicated by the pre-stored information;
determining whether the CEIs indicate that at least one of the services affects an overall CEI more than another one of the services; and
after changing the customer from the first cluster to the second cluster, determining a lowest customer experience indicator (CEI) of the CEIs for the customer and automatically controlling at least one of issuance of a ticket for the customer based on the lowest CEI and forming a connection between the customer and a help desk representative.

11. An apparatus network based media processing (NBMP), the apparatus comprising:
at least one memory configured to store computer program code;
at least one processor configured to access the computer program code and operate as instructed by the computer program code, the computer program code including:
providing code configured to cause the at least one processor to provide networked services to a customer;
measuring code configured to cause the at least one processor to measure a plurality of key performance indicators (KPIs) representing qualities of provision of the services to the customer;
obtaining code configured to cause the at least one processor to obtain, in response to obtaining the KPIs, one or more dynamic KPI weights based on classifications of the KPIs as indicated by pre-stored information based on at least a first cluster of first customers in which the customer is preassigned;
normalizing code configured to cause the at least one processor to normalize values indicated by the KPIs and separating the normalized values into at least a first group and a second group based on priority information for each of the KPIs as indicated by the pre-stored information; and
training code configured to cause the at least one processor to train a machine learning model by changing the customer from the first cluster to a second cluster of second customers based on at least one of the KPIs.

12. The apparatus according to claim 11, wherein the first cluster comprises first rankings of the services that is different than second rankings of the services of the second cluster.

13. The apparatus according to claim 12, wherein the first rankings indicate the one or more dynamic KPI weights of the services,

14. The apparatus according to claim 12, wherein the second rankings indicate second one or more dynamic KPI weights of the services different than one or more dynamic KPI weights of the services as indicated by the first rankings.

15. The apparatus according to claim 14, wherein changing the customer from the first cluster to the second cluster comprises determining whether the customer used a first one of the services more than a second one of the services over a time period.

16. The apparatus according to claim 11, wherein the second service comprises a higher rank in the second cluster than does the first service in the first cluster such that the higher rank indicates a greater dynamic weighting of that second service in the second cluster than for the first service in the second cluster.

17. The apparatus according to claim 11, wherein the first customers of the first cluster are predetermined as using the one or more services at a first similar rate over a previous time period, and
wherein the second customers of the second cluster are predetermined as using the one or more services at a second similar rate over the previous time period.

18. The apparatus according to claim 17, wherein changing the customer from the first cluster to the second cluster is further based whether the customer issued a complaint about the second service.

19. The apparatus according to claim 18, wherein changing the customer from the first cluster to the second cluster comprises changing the customer from the first cluster to the second cluster based on the customer issuing the complaint regardless of whether the customer used the second service at a higher rate than the first service over the time period.

20. A non-transitory computer readable medium storing a program causing a computer to execute a process, the process comprising:
providing networked services to a customer;
measuring a plurality of key performance indicators (KPIs) representing qualities of provision of the services to the customer;
obtaining, in response to obtaining the KPIs, one or more dynamic KPI weights based on classifications of the KPIs as indicated by pre-stored information based on at least a first cluster of first customers in which the customer is preassigned;
normalizing values indicated by the KPIs and separating the normalized values into at least a first group and a second group based on priority information for each of the KPIs as indicated by the pre-stored information; and
training a machine learning model by changing the customer from the first cluster to a second cluster of second customers based on at least one of the KPIs.
